(19) United States
(12) Patent Application Publication
(10) Pub. No.: US 2023/0278657 A1
(43) Pub. Date: Sep. 7, 2023

(54) Seated Collapsible Vehicle

(71) Applicant: Kartikey Gupta, Jaipur (IN)

(72) Inventor: Kartikey Gupta, Jaipur (IN)

(21) Appl. No.: 18/008,170

(22) PCT Filed: Jun. 3, 2021
(86) PCT No.: PCT/IN2021/050535

§ 371 Date: Dec. 4, 2022

(30) Foreign Application Priority Data
Jun. 4, 2020 (IN) 202011023390

(51) Int. Cl. B62K 15/00; B62K 21/16; B62K 25/04; B62J 1/02

(52) U.S. Cl. CPC B62K 15/006; B62K 21/16; B62K 25/04; B62J 1/02; B62K 2204/00

(57) ABSTRACT

The invention relates to a Seated Collapsible Vehicle. The user can fold it and carry it as a trolley whenever needed and can be used as a vehicle by unfolding it. The vehicle can be powered by an external source like motor or an engine or by human power. The vehicle comprises of a front armature connected to the rear armature by a hinge. The rear armature also comprises retractable fork for the rear wheel. The rear armature also comprises the saddle armature, mounted over a hinge. The saddle armature mounts saddle with the help of saddle mounting mechanism. Front armature comprises a encloser for battery and electronics, the foot rests are also mounted on front armature for resting legs while riding. Front fork comprises front wheel and rotatable mounted on front armature with the help of bearings. Front fork has an extension rod which mounts handlebar at other end. The extension rod can extend and retract for the purpose of folding and dragging invention like a trolley.

### TECHNICAL FIELD

This invention relates to a compact seated collapsible vehicle, which can be dragged like a trolley in collapsed configuration.

### BACKGROUND ART

Background description includes information that may be useful in understanding the present invention. It is not an admission that any of the information provided herein is prior art or relevant to the presently claimed invention, or that any publication specifically or implicitly referenced is prior art.

With energy independence, energy cost, and environment concerns becoming more important every year, it is desirable to reduce the consumption of energy in every sector, including transportation, which accounts for 28 percent of energy usage. Although mass transit Systems are often available and can be effective at reducing cost and pollution, there are still various problems that limit consumers will ingress to travel by bus or Subway instead of in their cars. One of the most important issues affecting the widespread use of mass transit is the first mile and last mile problem. Individuals need to travel to and from the mass transit station, which is usually located some distance away from their home or workplace. To get to the bus or train station, individuals would typically need to walk or bike and spend more time or effort than they want to, or arrive there by car, often requiring a parking fee. If the individual drives or bikes from home to the station, the car or bike would typically need to be left at the station because it is not allowed on the bus or subway. The individual would still lack a way of getting from the station to the ultimate destination.

A number of Solutions have been proposed to overcome this problem, including community transportation Such as feeder transport and ride or car sharing programs, however, these methods require a social infrastructure that is often either not available or not extensive enough to meet commuter needs. Other solutions involve various forms of portable transport, Such as bicycles. Most of these personal forms of transportation are relatively bulky and present challenges in storage at both ends of the commute, as well as transport within most public transport systems. Therefore, it would be desirable to have a portable personal mobility device that can take people from their homes to the station, one that is foldable and lightweight so that they can carry it with them on the mass transit vehicle, and use it again to get from the transit station to their final destination.

US 2015/0068828A1—A Foldable electrical vehicles and related charging infrastructure are described. The foldable electrical vehicle generally includes three structural armatures (front and rear wheel bearing armatures and a seat-bearing armature) that are pivotally interconnected along their lengths such that they may be pivoted between a closed position wherein the three armatures are disposed roughly parallel to each other in a compact collapsed configuration, and an open riding configuration wherein an angular relation is formed between the armatures.

Conventional options for bikes are generally too cumbersome and heavy to be taken onto the bus or train. While there are some lightweight options, what is needed, therefore, is a small and lightweight scooter that can be easily folded and transported when not in use.

### SUMMARY OF INVENTION

One or more drawbacks of conventional systems and process are overcome, and additional advantages are provided through the apparatus and a method as claimed in the present disclosure. Additional features and advantages are realized through the technicalities of the present disclosure. Other embodiments and aspects of the disclosure are described in detail herein and are considered to be part of the claimed disclosure.

A seated electric vehicle comprises a front armature is connected to the rear armature by hinge. rear armature can rotate with respect to front armature, as hinge forms a rotational joint between the two. Rear armature is in mesh with the retractable rear fork. They together form a rotatory curn sliding joint helps in collapsing vehicle. Retractable rear fork mounts the rear wheel. The rear armature mounts the saddle armature by a hinge. The saddle armature mounts saddle by means of saddle mounting mechanism. Front fork constitutes a retractable handle that mounts handlebar at other end. Front armature comprises encloser which encloses battery and electronics, the foot rests are mounted on the front armature for resting legs while riding. Foot rest folds by rotating in upward direction. The rear wheel is an electric hub motor.

Front fork rotatable mounted on front armature with the help of bearings and comprises front wheel. Handlebar, handle, front fork, front wheel in mesh with front armature forms a steering system for the vehicle. The handle can extend and retract for the purpose of folding. The lock is used to lock handle in place in expanded and collapsed configurations. The lock helps to lock the acute angle between rear armature and front armature. It comprises of a lock pin and holes to insert pin. Together the mesh forms a lock to hold the angle. The lock pin helps to lock rotation and sliding between rear armature and retractable rear fork. In expanded configuration, the holes in rear armature, retractable rear fork and lock pin together form a mesh for the purpose. The rear armature and retractable rear fork together with lock form a load bearing member. The rear armature also mounts the saddle armature, rotatable mounted by the hinge at an angle to the rear armature and supported by a means. It folds along the rear armature. The hinge holds saddle armature rigidly. The saddle is mounted on saddle armature by saddle mounting mechanism, the mechanism comprises a disk at an angle for the purpose of changing the angle of saddle when collapsing, by rotating it. Saddle and angled disk have an axially rotatable joint.

In collapsed configuration of seated collapsible vehicle, the front armature and rear armature are parallel to each other. Retractable rear fork is retracted inside the rear armature. The saddle is rotated half a circle, it become perpendicular to saddle armature by saddle mounting mechanism. Both the front wheel and rear wheel becomes parallel to each other as retractable rear fork and rear armature have a rotatable linkage. Saddle armature is a U section folds about hinge, it overlaps rear armature. handle retracts inside front fork and handlebar is further folded. Lock is used to keep handle in desired position. Foot rests are folded upward and becomes parallel to front armature. The retractable rear fork comprises a plate which meshes with hook in front fork and with Lock pin together in forms a lock. Lock keep both wheels' parallel, retains retractable rear fork inside rear armature. The saddle is mounted on angled disk. Angled disk is rotatable mounted on saddle armature. The saddle and saddle armature are at an angle. saddle is rotated half a circle and perpendicular to saddle armature. The angled disk provides a change in orientation of saddle, which helps in achieving portability and a saddle position to sit in collapsed configuration.

The procedure to collapse the invention is, Foot rest folds upward and parallel to front armature. The handle is retracted inside front fork which is mounted in front armature. Further handlebar is collapsed. the saddle is rotated to change the angle. The lock pin is removed retractable rear fork retracts into rear armature. Lock between front armature and rear armature is detached. Front fork and retractable rear fork are rotated. Front wheel and Rear wheel becomes parallel to each other. A plate from retractable rear fork meshes with hook from front fork and a lock pin is inserted, together forms a rigid lock. The saddle armature is rotated about hinge and saddle armature becomes parallel to rear armature. A magnet or any retracting mechanism is used to hold in place. The invention is collapsed configuration needs minimum space to store. To drag invention like a trolley handle can be extended out to purpose a handle for trolley. Both the front wheel and rear wheel together act as wheels of a trolley.

Another exemplary embodiment of the present invention. the front armature mounts two bearing for mounting the front fork. The front armature mounts an enclosure for batteries and electronic circuitry, the controller and the footrest. The front fork mounts front wheel which could be powered or non-powered. The front fork houses retractable handle. They together form a rotatory curn sliding joint helps in collapsing vehicle, connected by means quick release clamp and a spring button aids indexing purpose of the handle. The spring button is a simple pin with a spring attached. The circular slots in front fork and the extension fork meshes with spring button thus helps in indexing. By pressing spring button user can retract the handle. The handle mounts the foldable handlebar at the other end. The foldable handlebar has nut & threads mechanism to attach both pipes straight in expanded configuration to act as a handlebar to ride; could collapse when needed. The front armature also mounts a rear armature through a hinge. Both front armature and rear armature contains a locking mechanism to rigidly sustain the angle. The rear armature has retractable rear fork for mounting rear wheel. They together form a rotatory curn sliding joint helps in collapsing vehicle. The retractable rear fork has quick release clam to lock relative motion. Spring button solves indexing of retractable rear fork. Retractable rear fork mounts wheel powered or non-powered. The rear armature also accompanies mounting for the seat armature. The seat armature can rotate over the mounting by means of hinge. The hinge constitutes hollow pin and bush mechanism. The seat armature is supported by a nylon strap. Saddle is connected to saddle armature by saddle mounting mechanism. A foldable stand is provided to maintain vertical stance of vehicle both in collapsed and expanded configuration. The locking mechanism between front armature and rear armature consist of a lock mounted on rear armature and rotatable lock mounted on front armature and a spring strip which is in mesh with rotatable lock. The rotatable lock also mounts the nylon strap. both in mesh locks the angle. The spring strip acts as a means to keep rotatable lock in place and also holds seat armature when folded. The nylon strap is mounted on rotatable lock, in expanded configuration keeps in mesh. Hinge holds front armature and rear armature together. the quick release clamp helps in fastening handle to front fork. Bearing is used to provide relative rotational motion between front armature and front fork.

The procedure to collapse another exemplary embodiment of the invention. The rear wheel is rotated by right angle. The quick release on rear armature is released to retract rear fork inside rear armature, after that seat is rotated for half a circle to change orientation perpendicular to saddle armature. The handle is rotated by a right angle. The lock between front and rear armature is released by pressing Spring strip. As front armature is lifted to straight, the lock between retractable rear fork and front clamps. Both wheels are in same plane, desired to achieve trolley. After that seat armature is rotated upward and becomes parallel to rear armature. Now the front quick release clamp is released; the handle is collapsed inside. The saddle armature locking mechanism is used to secure seat armature in collapsed configuration. A slot in spring strip meshes with the latch in seat armature. The handlebar mounts the throttle, brake lever and digital display for information. Handlebar is collapsed by unscrewing the bolt and thread mechanism, both the parts of handlebar are folded downward. The seat mounting mechanism responsible for aligning seat in expanded and collapsed configuration. The system consists of rectangular having protrusions meshing inside the holes in seat pillar and seat post. Thus helps to sustain position of saddle in both configurations.

In accordance with another exemplary embodiment of the present invention, the suspension system and is introduced. The front fork & rear fork is divided into three section. Fork, spring & pipe. The fork and pipe are in mesh and spring helps in reducing shocks. A rib is provided between the two to stop relative motion. The locking system for maintaining acute angle is achieved by two rods. First rod is hinged with front armature and the other rod is hinged with retractable rear fork through a clamp, rotatable linkage with retractable rear fork. Both rods hinge at center; have a lock to act as a straight member in loading conditions. While in collapsed configuration lifts upward to collapse.

In accordance with another exemplary embodiment of the present invention, the seat armature fastens a leaf spring connected to nylon strap. The spring act as member to absorb vibrations while riding. The embodiment also consists of a paddling system converts human energy into motion. Utilization of both electric and human energy makes this vehicle hybrid. The paddles support legs and transfers energy. Paddles are connected to rope to transmit force. The rope passes through guide pulley. The rope is attached to a pulley, act as a member to convert force exerted by rope to rotational motion. The pulley is attached to a one way bearing. One way bearings transfers rotation in one direction only. A recoiling spring is attached between the front fork and pulley. As the paddle is pressed the rope transfers force to pulley. The pulley rotates in clockwise direction. One way bearing transfers the motion. The wheel rotates and propel the vehicle. The recoil spring stores the energy, as the foot is lifted from the paddle. The spring recoils and restores the position of pulley and the paddle, the one way bearing does not transmit the rotation motion in this direction. Both paddles in conjunction propels the vehicle forward.

While the embodiments of this invention are described, it is understood that further variations and modifications may be made without departing from the scope of invention.

Various objects, features, aspects, and advantages of the inventive subject matter will become more apparent from the following detailed description of preferred embodiments, along with the accompanying drawing figures in which like numerals represent like components.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein, wherein:

FIG. 1 shows: A Perspective side view of the invention in an expanded configuration, ready for a user to ride.

FIG. 2 shows: A Perspective side view of the invention in collapsed configuration.

FIG. 3a shows: A side view of invention. Saddle at an angle with saddle armature.

FIG. 3b shows: A side view of invention. Saddle at perpendicular with saddle armature.

FIG. 4 shows: Another exemplary embodiment in expanded configuration with a nylon strap (means).

FIG. 5 shows: A locking mechanism in expanded configuration.

FIG. 6a shows: An intermediate collapsed configuration.

FIG. 6b shows: Another collapsed configuration showing structure as a trolley.

FIG. 6c shows: Another collapsed configuration showing folded handlebar and saddle mounting mechanism.

FIG. 7 shows: Another exemplary embodiment introducing suspension mechanism.

FIG. 8 shows: Another exemplary embodiment introducing hybrid mechanism and leaf spring suspension.

FIG. 9 shows: The front wheel and paddling system in exploded view.

### DESCRIPTION OF EMBODIMENTS

While the embodiments of the disclosure are subject to various modifications and alternative forms, specific embodiment thereof have been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

The present invention makes a disclosure regarding a technology pertaining to a seated electric vehicle.

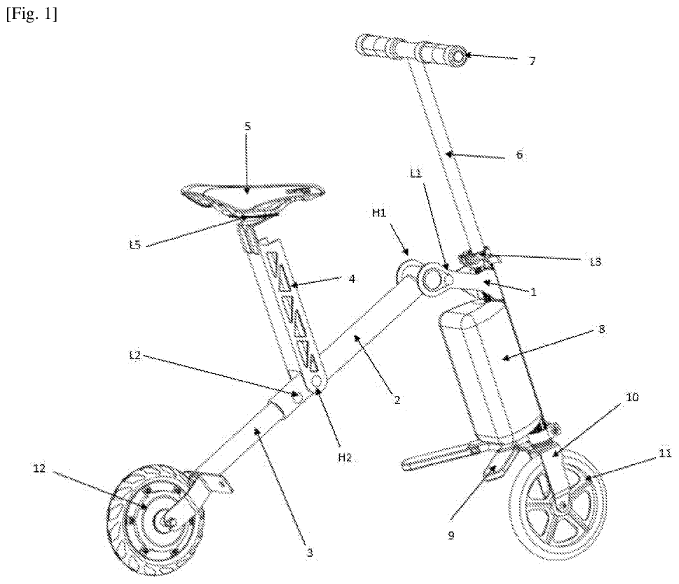

Reference may be made to FIG. 1 indicating a perspective side view of the invention in an expanded state, ready for the user to ride. The front armature (1) is connected to the rear armature (2) by hinge (H1). rear armature (2) can rotate with respect to front armature (1), as hinge (H1) forms a rotational joint between the two. Rear armature (2) is in mesh with the retractable rear fork (3). They together form a rotatory curn sliding joint helps in collapsing vehicle. Retractable rear fork (3) mounts the rear wheel (12). The rear armature (2) mounts the saddle armature (4), mounted by the hinge (H2). The saddle armature (4) mounts saddle (5) on the saddle mounting mechanism (L5). Front fork (10) constitutes a retractable handle (6) that mounts handlebar (7) at other end. Front armature (1) comprises encloser (8) encloses battery and electronics, the foot rests (9) are mounted on the front armature (1) for resting legs while riding. Foot rest (9) can folded by rotating in upward direction. The rear wheel (12) is an electric hub motor.

Front fork (10) rotatable mounted on front armature (1) by means of bearings and comprises front wheel (11). Handlebar (7), handle (6), front fork (10), front wheel (11) in mesh with front armature (1) forms a steering system for the vehicle. The handle (6) can extend and retract for the purpose of folding. The lock (L3) is used to lock handle (6) in place in expanded and collapsed configurations. Handlebar (7) can be further folded.

The lock (L1) helps to lock the acute angle between rear armature (2) and front armature (1). It comprises of a lock pin and holes to insert pin. Together the mesh forms a lock to hold the angle.

The lock pin (L2) helps to lock rotation and sliding between rear armature (2) and retractable rear fork (3). In expanded configuration, the holes in rear armature (2), retractable rear fork (3) and lock pin together form a mesh for the purpose. The rear armature (2) and retractable rear fork (3) together with lock (L2) form a load bearing member.

The rear armature (2) also mounts the saddle armature (4). Rotatable mounted by the hinge (H2) at an angle to the rear armature (2) and supported by a means. It folds along the rear armature (2). The hinge (H2) holds it from further rotation of saddle armature (4). The saddle (5) is mounted on saddle armature (4) by saddle mounting mechanism (L5), the mechanism comprises a disk (13) at an angle for the purpose of changing the angle of saddle (5) when collapsing, by rotating it. Saddle (5) and angled disk have an axially rotatable joint.

The saddle armature (4) and rear armature (2) can also incorporate a suspension system for the purpose of smooth riding. Also rear armature (2) and rear armature (3) can also form a suspension for the purpose of comfort.

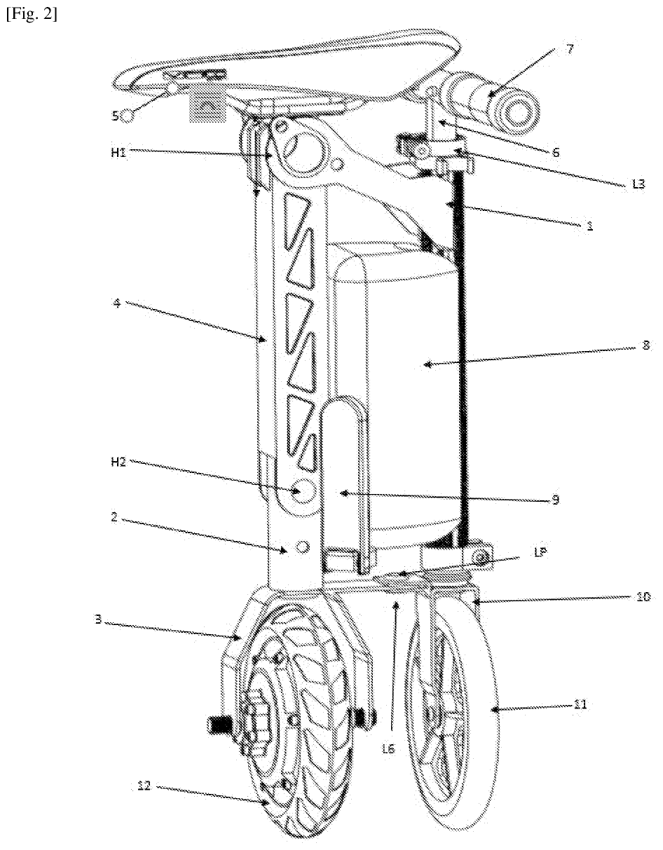

Referring FIG. 2. Shows the collapsed view of the invention. The front armature (1) and rear armature (2) are parallel to each other. Retractable rear fork (3) is retracted inside the rear armature (2). The saddle (5) is rotated half a circle, it become perpendicular to saddle armature (4) by saddle mounting mechanism (L5). Both the front wheel (11) and rear wheel (12) becomes parallel to each other as retractable rear fork (3) and rear armature (2) have a rotatable linkage. Saddle armature (4) is a U section folds about hinge (H2), it overlaps rear armature (2). handle (6) retracts inside front fork (10) and handlebar (7) is further folded. Lock (L3) is used to keep handle (6) in desired position. Foot rests (9) are folded upward and becomes parallel to front armature (1).

The retractable rear fork (3) comprises a plate which meshes with hook in front fork (10) and with Lock pin (LP) together in forms a lock (L6). Lock (L6) keep both wheels' parallel, retains retractable rear fork (3) inside rear armature (2), restricts from retracting out.

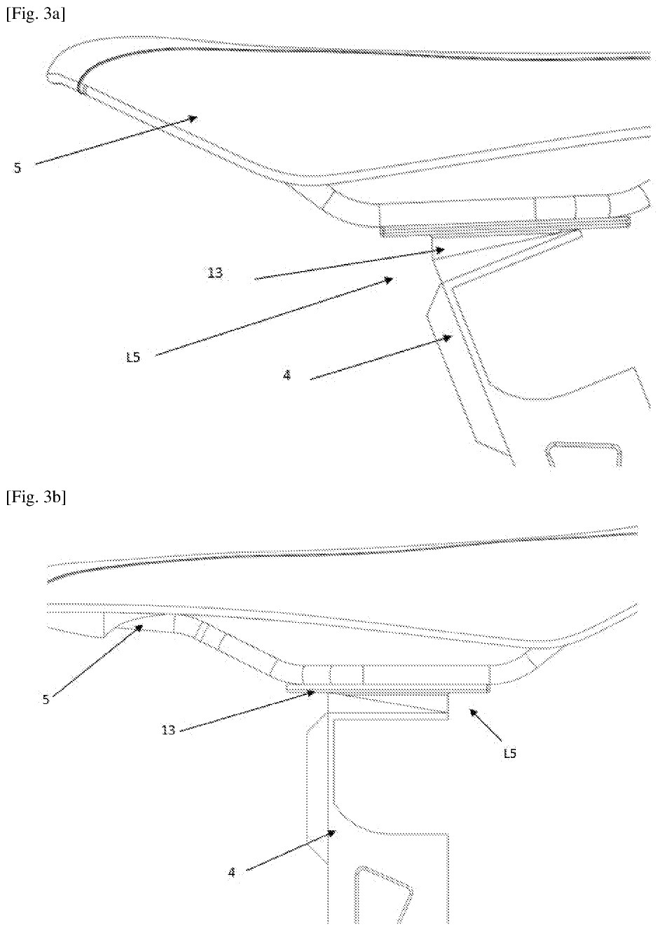

Referring to FIGS. 3a and 3b are the two position of saddle describes the saddle mounting mechanism (L5). In 3a saddle (5) is mounted on angled disk (13). Angled disk (13) is rotatable mounted on saddle armature (4). The saddle (5) and saddle armature (4) are at an angle. In 3b the saddle (5) is rotated half a circle and perpendicular to saddle armature (4). The angled disk (13) provides a change in orientation of saddle (5), which helps in achieving portability and a saddle position to sit in collapsed configuration.

Referring to FIGS. 1 and 2. The procedure to collapse invention is described. Foot rest (9) folds upward and parallel to front armature (1). The lock (L3) is detached, the handle is retracted inside front fork (10) which in mounted in front armature (1). Further handlebar (7) is collapsed. the saddle (5) is rotated to change the angle as shown in FIG. 3a, 3b. The lock pin (L2) is removed retractable rear fork (3) retracts into rear armature (2). The lock pin is detached from lock (L1). Front fork (10) and retractable rear fork (3) are rotated. Front wheel (11) and Rear wheel (12) becomes parallel to each other. A plate from retractable rear fork (3) meshes with hook from front fork (10) and a lock pin (LP) is inserted, together forms a rigid lock (L4). The saddle armature (4) is rotated about hinge (H2) and saddle armature (4) becomes parallel to rear armature (2). A magnet or any retracting mechanism is used to hold in place. The invention is collapsed configuration needs minimum space to store.

To drag invention like a trolley handle (6) can be extended out to purpose a handle for trolley. Both the front wheel (11) and rear wheel (12) together act as wheels of a trolley.

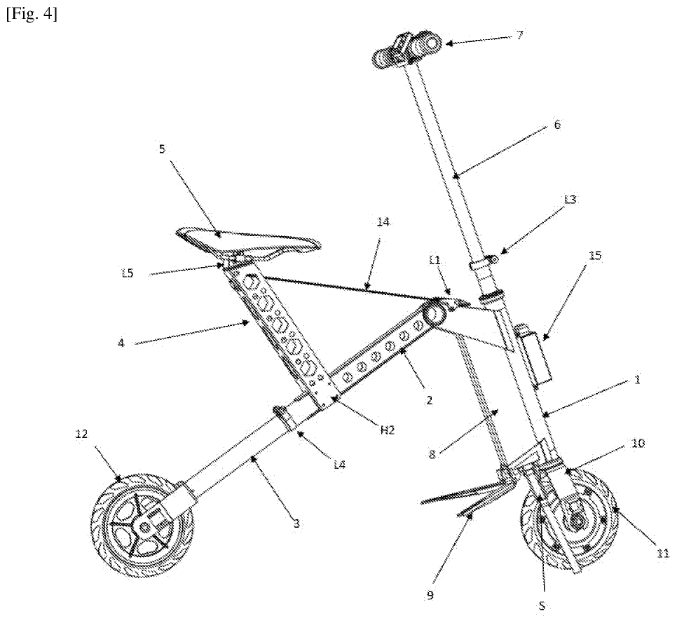

In accordance with another exemplary embodiment of the present invention, as shown in FIGS. 4, the front armature (1) mounts two bearing for mounting the front fork (10). The front armature (1) mounts an enclosure for batteries and electronic circuitry, the controller (15) and the footrest (9). The front fork (10) mounts front wheel (11) which could be powered or non-powered.

The front fork (10) houses retractable handle (6). They together form a rotatory curn sliding joint helps in collapsing vehicle, connected by means quick release clamp (L3) and a spring button aids indexing purpose of the handle (6). The spring button is a simple pin with a spring attached. The circular slots in front fork (10) and the extension fork (6) meshes with spring button thus helps in indexing. By pressing spring button user can retract the handle. Handle (6) mounts the foldable handlebar (7).

The foldable handlebar (7) has nut & threads mechanism to attach both pipes straight in expanded configuration to act as a handlebar to ride; could collapse when needed.

The front armature (1) also mounts a rear armature (2) through a hinge (H1). Both front armature (1) and rear armature (2) contains a locking mechanism (L1) to rigidly sustain the angle.

The rear armature (2) has retractable rear fork (3) for mounting rear wheel (12). They together form a rotatory curn sliding joint helps in collapsing vehicle. The retractable rear fork (3) has quick release clam (L4) to lock relative motion. Spring button solves indexing of retractable rear fork (3). Retractable rear fork (3) mounts wheel (12) powered or non-powered. The rear armature (2) also accompany mounting for seat armature (4).

A foldable stand (S) is provided to maintain vertical stance of vehicle both in collapsed and expanded configuration.

The seat armature (4) can rotate over the mounting by means of hinge (H2). The hinge (H2) constitutes hollow pin and bush mechanism. The seat armature (4) is supported by a nylon strap (14). Saddle (5) is connected to saddle armature (4) by saddle mounting mechanism (L5).

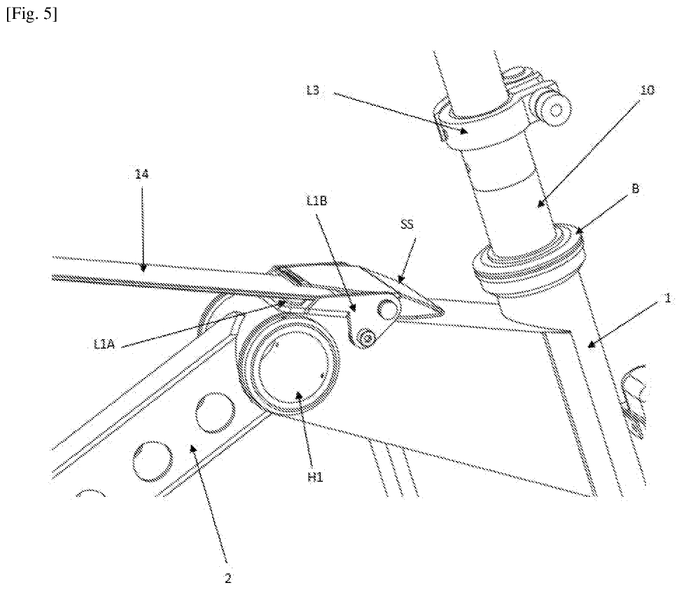

Referring to FIG. 5, The locking mechanism consist of lock (L1A) and rotatable lock (L1B) and a spring strip (SS) which is in mesh with rotatable lock (L1B). The rotatable lock (L1B) also mounts the nylon strap (14). (L1A) & (L1B) both in mesh locks the angle. The spring strip (SS) acts as a means to keep lock (L1B) in place and also holds seat armature (4) when folded. The nylon strap (5) is mounted on lock (L1B), in expanded configuration keeps (L1B) in mesh. Hinge (H1) holds front armature (10) and rear armature (2) together. (L3) the quick release clamp helps in fastening handle (6) to front fork (10). Bearing (B) is used to provide relative rotational motion between front armature (1) and front fork (10).

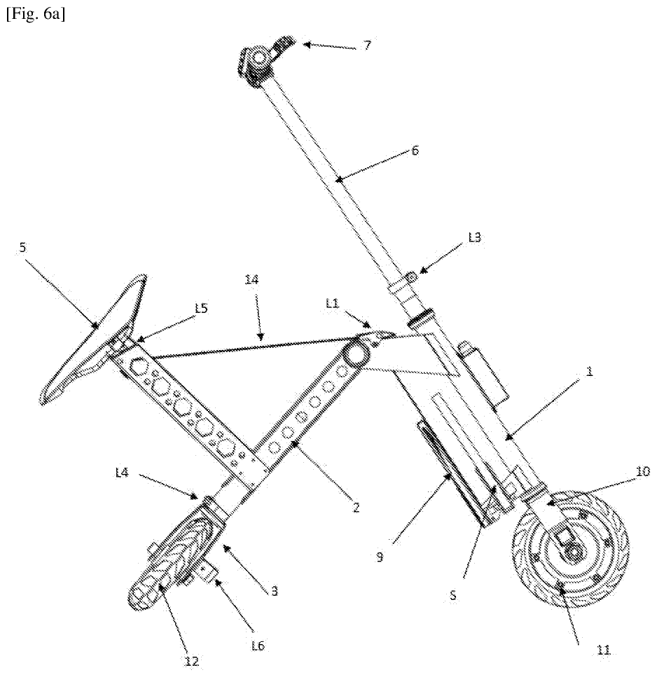

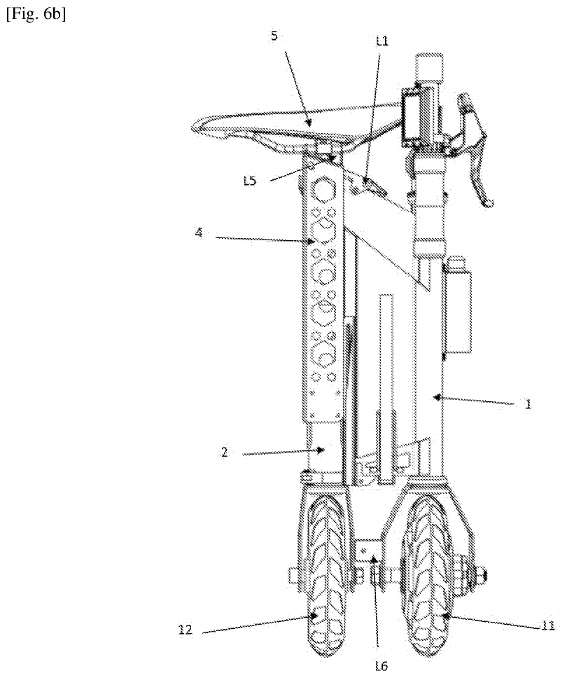

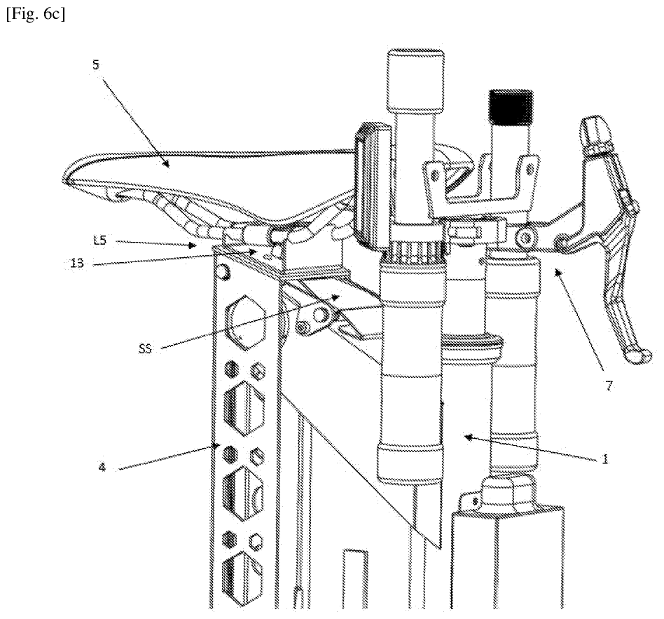

Referring to FIGS. 6a & 6b, represent method for collapsing the invention. The rear wheel (12) is rotated by right angle. The quick release (L4) on rear armature (2) is released to retract rear fork (3) inside rear armature (2), after that seat (5) is rotated for half a circle to change orientation perpendicular to saddle armature (4). The handle (6) is rotated by a right angle. The lock (L1) is released by pressing Spring strip. As front armature (1) is lifted to straight, the lock (L6) clamps. Both wheels (12) & (13) are in same plane, desired to achieve trolley. After that seat armature (4) is rotated upward and becomes parallel to rear armature (2).

Now the front quick release clamp (L3) is released. The handle (6) is collapsed inside.

Referring to FIG. 6c. The saddle armature locking mechanism is used to secure seat armature (4) in collapsed configuration. A slot in spring strip (SS) meshes with the latch in seat armature (4). The handlebar (7) mounts the throttle, brake lever and digital display for information. The (7) is collapsed unscrewing the bolt and thread mechanism, both the parts of handlebar are folded downward.

The seat mounting mechanism (L5) responsible for aligning seat in expanded and collapsed configuration. The system consists of rectangular having protrusions meshing inside the holes in seat pillar and seat post. Thus helps to sustain position of saddle in both configurations.

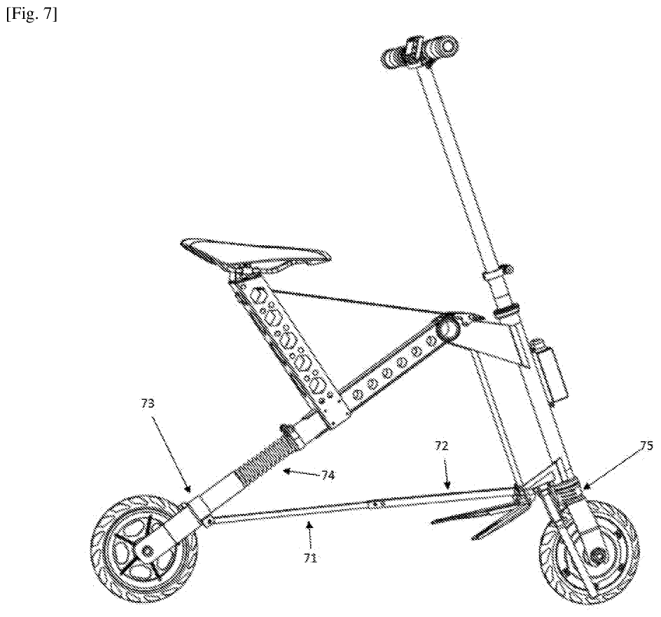

Referring to FIG. 7. In accordance with another exemplary embodiment of the present invention, the suspension system (74) and (75) is introduced. The front fork & rear fork is divided into three section. Fork, spring & pipe. The fork and pipe are in mesh and spring helps in reducing shocks. A rib is provided between the two to stop relative motion.

The locking system for maintaining acute angle is achieved by two rods (71) & (72). The rod (71) is hinged with front armature (1). The rod (72) is hinged with retractable rear fork (3) through a clamp (73), (73) rotatable linkage with retractable rear fork (3). Both rods (71) and (72) hinges at center, have a lock to act as a straight member in loading conditions. While in collapsed configuration (71) and (72) lifts upward to collapse. The front armature (1) mounts nylon strap (14).

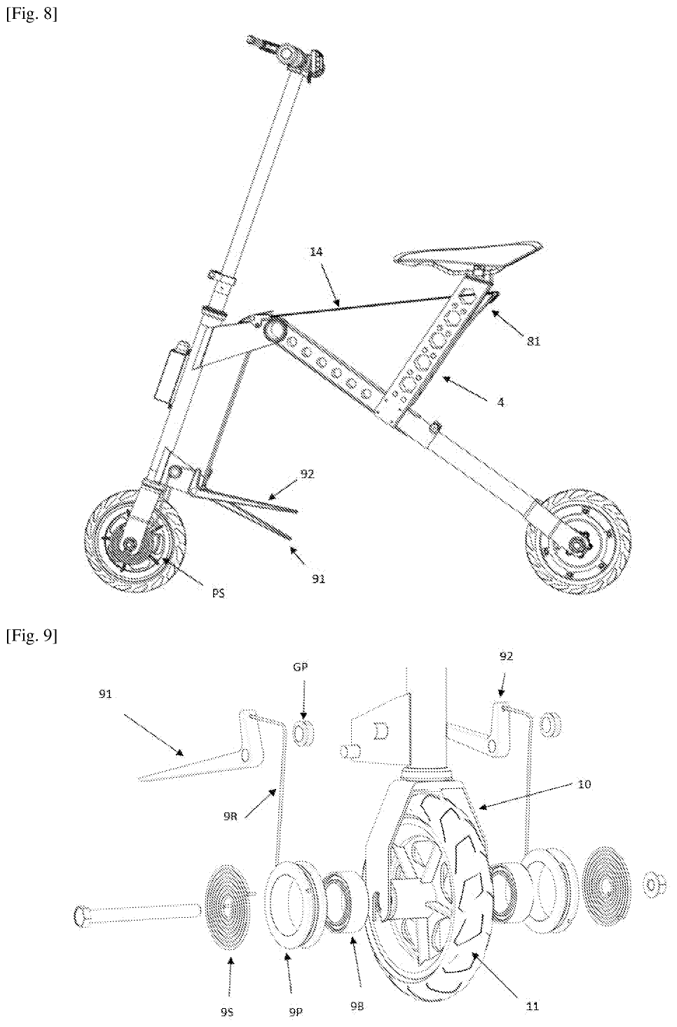

Referring to FIG. 8. In accordance with another exemplary embodiment of the present invention, the seat armature (4) fastens a leaf spring (81) connected to nylon strap (14). The spring act as member to absorb vibrations while riding.

The embodiment also consists of a paddling system (PS) converts human energy into motion. Utilization of both electric and human energy makes this vehicle hybrid. The (91) and (92) are paddles.

Referring to FIG. 9. The (91) and (92) are paddles to support legs and to transfer energy. Paddles are connected to rope (9R) to transmit force. The rope (9R) passes through guide pulley (GP), (GP) guides the rope. The rope (9R) is attached on pulley (9P). (9P) act as a member to convert force exerted by rope to rotational motion. The pulley (9P) is attached to one way bearing (9B). One way bearings transfers rotation in one direction only same as ratchet mechanism. A recoiling spring is attached between the front fork (10) and pulley (9P). As the paddle (91) is pressed the rope (9R) transfers force to pulley (9P). The pulley (9P) rotates in clockwise direction. One way bearing (9B) transfers the motion. The wheel (11) rotates and propel the vehicle. The recoil spring (9S) stores the energy, as the foot is lifted from the paddle. The spring recoils and restores the position of pulley (9P) and paddle (91), the one way bearing (9B) does not transmit the rotation motion in this direction. Both paddles (91) and (92) in conjunction propels the vehicle forward.

While the embodiments of this invention are shown and described, it is understood that further variations and modifications may be made without departing from the scope of invention.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particulars claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogue to “at least one of A, B and C, etc.” is used, in general such a construction is intended in the sense one having skill in the art would understand the convention (e.g., “a system having at least one of A, B and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the present disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

1. A seated collapsible vehicle assembly, comprising:
a front armature (1) being provided at least one; a paddling system (PS) and an electric powertrain; wherein
the front armature (1) mounts a front fork (10) being connected to a selectable rigid or retractable handle, the handle (6) being comprised either of a foldable handlebar (7) or a rigid handlebar;
a rear armature (2) at an angle through a hinge (H1) provided with locking mechanism (L1) to rigidly sustain the angle; wherein the rear armature (2) being connected with the retractable rear fork (3) and mounts saddle armature (4), the said saddle armature mounts a saddle (5) by a saddle mounting mechanism (L5) and supported by a means (14) wherein the saddle armature (4) is adapted to be positioned roughly parallel to the rear armature (2) in a collapsed configuration through a saddle armature locking mechanism;
the front fork (10) and retractable rear fork (3) mounts wheel powered or non-powered; and
retractable attachments are retracted inside in collapsed configuration;
characterized in that
the front fork (10) and the retractable rear fork (3) accommodate a locking mechanism (L6) for locking the wheel in aligned position while the whole structure is in collapsible configuration; and
the fixed or retractable handle (6) is optionally extended out for forming a trolley structure having handle; and
wherein the user may sit on saddle (5) collapsed or expanded configuration.

2. The assembly as claimed in claim 1, wherein the means (14) to absorb vibration is selectable from a nylon strap, any metallic or non-metallic material with elastic properties.

3. The assembly as claimed in claim 1, wherein the front fork (10) and the retractable rear fork (3) accommodate lock (L3) and (L4) respectively, to secure the assembly in place, selectable from pins or fastening mechanisms or a quick release clamp provided with a spring button for indexing of retractable attachments.

4. The assembly as claimed in claim 1, wherein the rear armature (2) and front armature (1) is configured with a locking mechanism (L1) selectable from pins or fastening mechanisms or a first lock (LA1) and a second rotatable lock (LB2) and a spring strip (SS) to hold second rotatable lock (LB2), which is in mesh with the first lock (LA1).

5. The assembly as claimed in claim 1, wherein the saddle armature locking mechanism in collapsed configuration is selectable from magnet or slit in a spring strip (SS) is configured to mesh with a grove in the saddle armature (4) or any fastening mechanism.

6. The assembly as claimed in claim 1, wherein the saddle armature (4) accommodates the saddle mounting mechanism (L5) selectable form magnets or fastening mechanisms or a rectangular spring strip with protrusions, which meshes with holes, both inside the saddle armature (4) and the saddle (5) to secure the saddle in place.

7. The assembly as claimed in claim 1, the front fork (10) and the retractable rear fork (3) consist a locking mechanism (L6) for locking the wheel in aligned position while the whole structure is in collapsible state selectable from a magnet or a u section meshes with a square pipe with holes to mesh spring button or fastening mechanisms.

8. The assembly as claimed in claim 1, wherein the paddling system (PS) is configured to drive the vehicle, and comprised of a pulley (9P) to guide a rope (9R), a wheel with recoiling module and paddles.

9. The assembly as claimed in claim 1, wherein the rear armature (2) and the front fork (10) are provided with a suspension system being divided into three sections: Fork, spring and pipe, wherein the fork and the pipe are in mesh with a rib in order to stop relative motion and the spring is used for reducing shocks.

10. The assembly as claimed in claim 1, wherein the saddle armature (4) mounts a leaf spring (81) connected to the means (14), acts as a member to absorb vibrations while riding.

11. The assembly as claimed in claim 1, wherein the foldable rods (71) and (72) sustain the angle between the front armature (1) and rear armature (2), the lock within two rods assists to act as rigid member.
